(19) United States
(12) Patent Application Publication
(10) Pub. No.: US 2016/0347371 A1
(43) Pub. Date: Dec. 1, 2016

(54) METAL BEAM WITH A LIMITED BENDING ANGLE

(71) Applicant: AUTOTECH ENGINEERING, A.I.E., Amorebieta-Etxano (ES)

(72) Inventors: Christophe CAZES, VERSAILLES (FR); Gregory GATARD, LEUVILLE-SUR-ORGE (FR); Emmanuel LEROY, VERRIERES LE BUISSON (FR); Matthieu NIESS, AVALLON (FR); Vincent BARELLI, LA VILLE DU BOIS (FR)

(21) Appl. No.: 15/108,557

(22) PCT Filed: Jan. 6, 2015
(86) PCT No.: PCT/EP2015/050117

§ 371 Date: Jun. 27, 2016

(30) Foreign Application Priority Data
Jan. 7, 2014 (FR) 1450096

(51) Int. Cl. B62D 21/15; B62D 65/02

(52) U.S. Cl. CPC B62D 21/15; B62D 65/02

(57) ABSTRACT

A metal beam for the production of a motor vehicle, including, at least, on one face means adapted to form, upon bending of the part, at least two bosses brought into contact by the bending, so that the bending of the structural part is limited when at least portions of opposing faces of two adjacent bosses abut.

### FIELD OF THE INVENTION

The present invention relates to the field of metal parts involved in the production of a metal framework, in particular a vehicles' chassis, underbody or bodywork or body.

In the following text either the term “chassis” or “underbody” will be used without it being limiting.

### BACKGROUND OF THE ART

Many metal parts have already been proposed for the production of a metal framework capable of deformation in the event of a sharp impact, to absorb the impact energy in order to limit the transmission of this energy to the interior of a vehicle.

In particular, parts capable of being deformed by bending, for example rails, have been proposed.

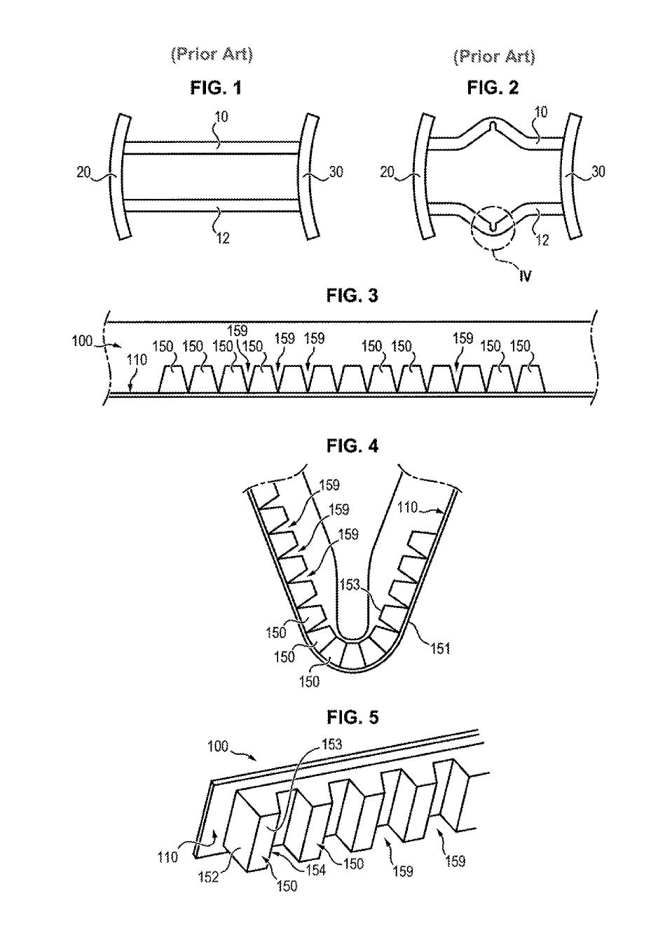

Thus it has been shown, by way of a non-limiting example in FIG. 1, two rails 10, 12, placed between a bumper structure 20 and a bodywork element 30 in operative states before impact, and in FIG. 2 the same rails 10, 12 after bending resulting from a sharp impact.

Moreover, many systems have been proposed to control the deformation of parts, in very different fields of application.

However, most proposed systems are complex, expensive and have an unsatisfactory reliability, so they cannot be implemented in the design for motor vehicle underbodies.

Thus, in the document EP 0369521, a structure formed by the combination of 4 rods equally spaced around an axis for supporting a steering wheel has been proposed. The size and complexity of such a structure do not allow transposition to the underbody of a vehicle.

More recently, structures comprising alternating non-deforming rigid areas and interspersed less rigid areas intended to be deformed when receiving pressure from the rigid areas that enclose them has been proposed, for example in JP2006-200703 and EP 2094555. Specifically these structures have at least 3 elements forming alternating at least two non-deforming rigid areas interspersed by a less rigid area to be deformed when under pressure from the rigid areas that enclose it. Again, due to the complexity, cost and lack of reliability related to the hazards of deformation of the less rigid areas, these solutions cannot be transposed to the production of motor vehicle underbodies.

### SUMMARY OF INVENTION

Noting that for a part subjected to bending loads, there is a risk of breakage if the bending angle becomes too great, the object of the present invention aims to provide means to limit the risk of such a breakage.

This object is achieved, according to the invention, with a structural part consisting of a structure selected from the group comprising a one-piece tube of any polygonal or curve section, for example a square tube, or a tube formed by assembling more parts and comprising, at least on one face, means adapted to form, upon bending of the part, at least two bosses that are brought into contact by bending so that the bending of the structural part is limited when at least portions of the opposing faces of two adjacent bosses abut.

As will be understood on reading the following description, the invention allows the production of motor vehicle underbody parts, in particular rails, so that during their bending, for example in the case of impact generating an axial pressure on the part, the aforesaid bosses come into contact at a certain bending angle and limit the bending of the part while absorbing energy. The invention thus also allows transferring the load and enabling the proper operation of the compression mechanisms, of bending and local ball and socket joints of the components of the underbody arranged downstream.

According to one embodiment, the part for forming a metal beam for the production of a motor vehicle comprises, at least on one face, at least two preformed bosses, for example a series of bosses distributed over its length and defining therebetween control section gaps so that the bending of the beam is limited when at least portions of the opposing faces of two adjacent bosses abut.

According to an advantageous feature of the present invention, the bosses define gaps therebetween, which section increases towards the top of the bosses.

According to another embodiment of the invention, the part comprises means adapted to be deformed during bending and thereby forming at least two bosses likely to come into contact if the bending angle exceeds a threshold.

Other characteristics, objects and advantages of the present invention will become apparent from reading the detailed description that follows, and from the accompanying drawings given as non-limiting examples and in which:

FIGS. 1 and 2, mentioned above, show schematically an example of bending rails, respectively before and after an impact,

FIG. 3 shows schematically, a part provided with bosses according to the present invention before bending,

FIG. 4 shows the same part after bending, and thus illustrates an enlarged view of the referenced area IV in FIG. 2,

FIG. 5 shows a perspective view of bosses, according to the present invention,

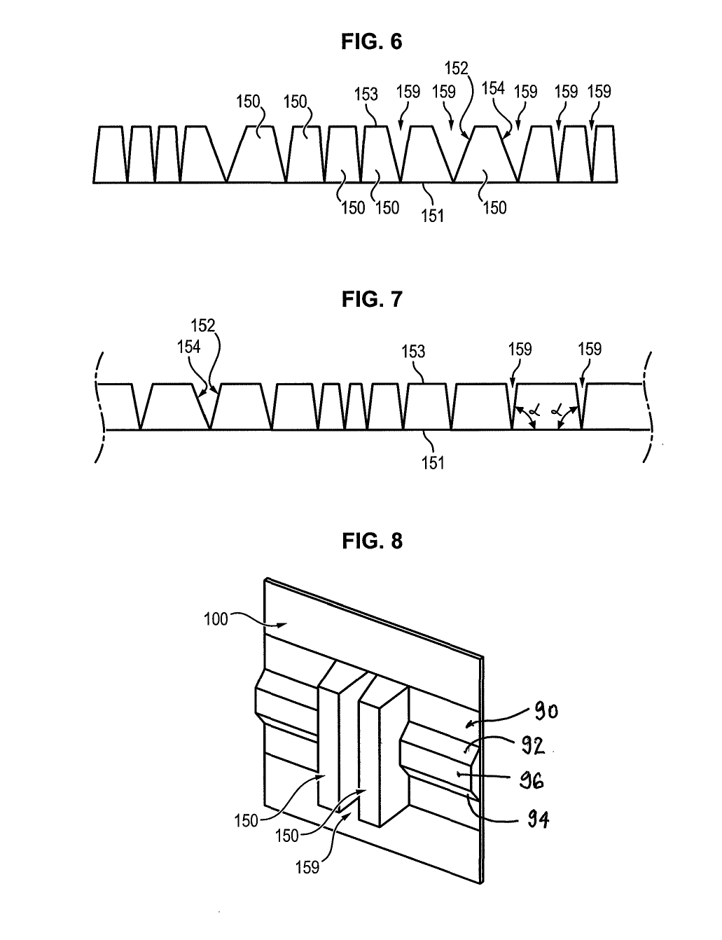

FIG. 6 shows schematically a variant in which the gaps formed between the bosses according to the present invention are of variable section along the length of the part,

FIG. 7 schematically shows another embodiment, according to the present invention, in which the bosses have varying widths along the length of the part,

FIG. 8 shows an embodiment, according to the present invention,

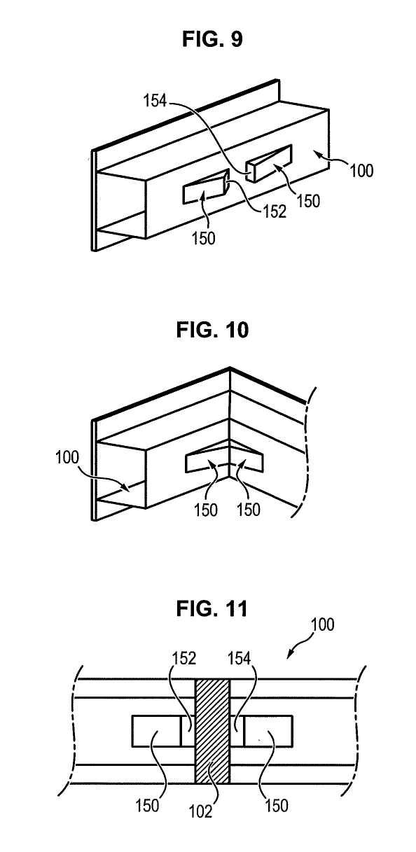

FIG. 9 shows an embodiment in which two bosses are formed by stamping of one face of the part,

FIG. 10 shows a perspective view of the part illustrated in FIG. 9, upon bending, and illustrates the limitation of the bending by the abutting of the two bosses formed by stamping,

FIG. 11 shows a front view of the part illustrated in FIG. 9,

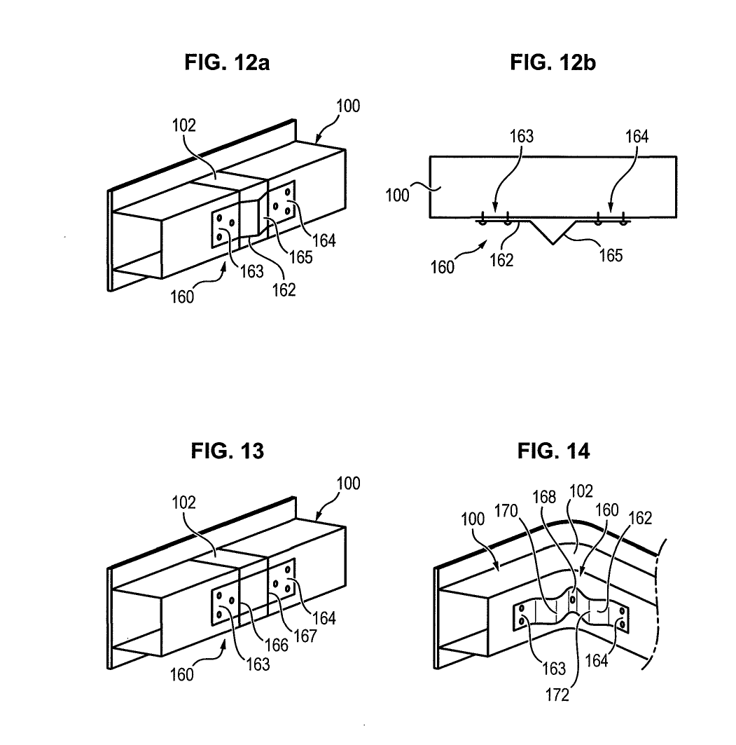

FIG. 12a shows a perspective view of a part, according to another embodiment of the present invention, before bending, while FIG. 12b shows a top view of this part before bending,

FIG. 13 shows a perspective view of a part, according to another embodiment of the present invention, before bending,

FIG. 14 shows a perspective view of a part, according to another embodiment of the present invention, after bending,

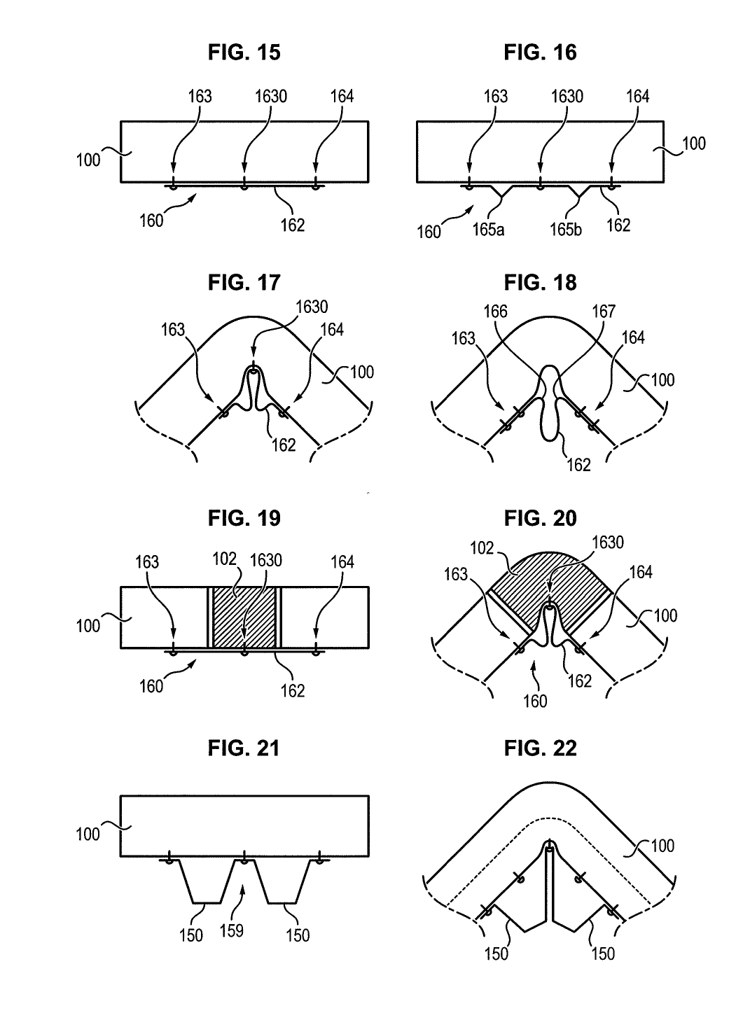

FIG. 15 shows a top view of the part according to FIG. 14 before bending,

FIG. 16 shows a top view of the part according to an embodiment of FIG. 15,

FIG. 17 shows a top view of the part according to FIG. 15 or 16 after bending,

FIG. 18 shows a top view of the part according to FIG. 12 or 13 after bending,

FIG. 19 shows a top view of the part according to FIG. 15 having an area with controlled mechanical properties before bending,

FIG. 20 shows a top view of the part in FIG. 19 after bending,

FIG. 21 shows a top view of the part according to FIG. 5 before bending,

FIG. 22 shows the part in FIG. 21 after bending,

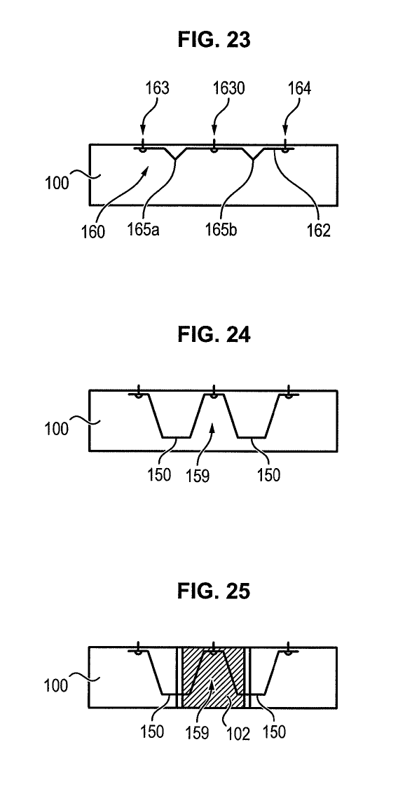

FIGS. 23, 24 and 25 show sectional views of parts, according to the invention, and illustrate the possibility of having the bosses on an interior face of the part,

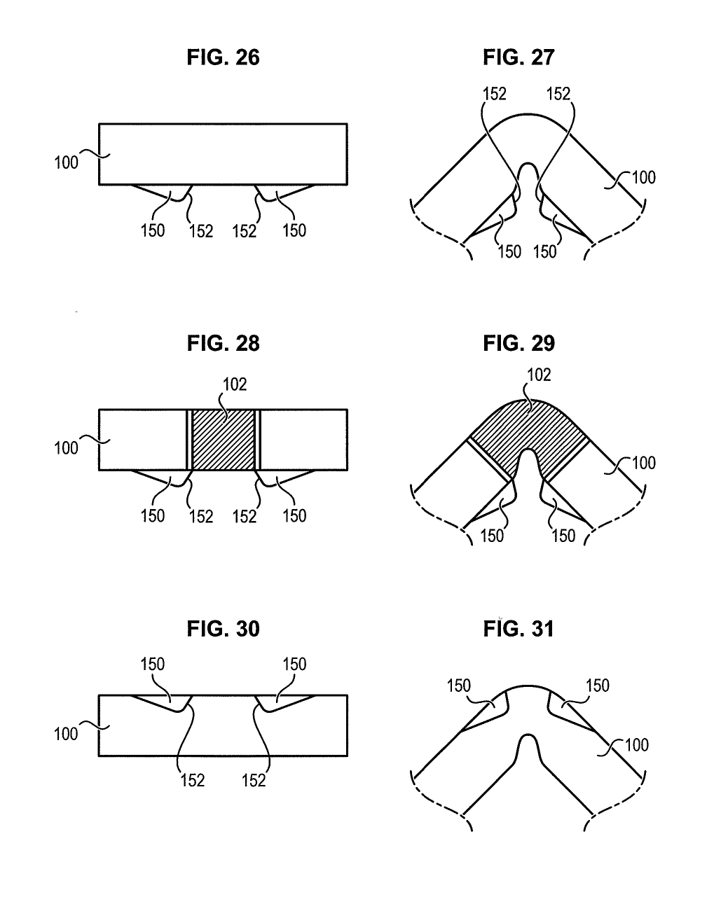

FIG. 26 shows a top view of the part in FIG. 9 before bending,

FIG. 27 shows a top view of the part in FIG. 26 after bending,

FIG. 28 shows an embodiment of FIG. 26 having a controlled mechanical resistance area at the level of the area intended to operate the bending,

FIG. 29 shows a top view of the part in FIG. 28 after bending,

FIG. 30 shows a sectional view of a variation of part of FIG. 9 in which the bosses formed by stamping are formed on the inner surface of the part, before bending,

FIG. 31 shows the part in FIG. 30 after bending,

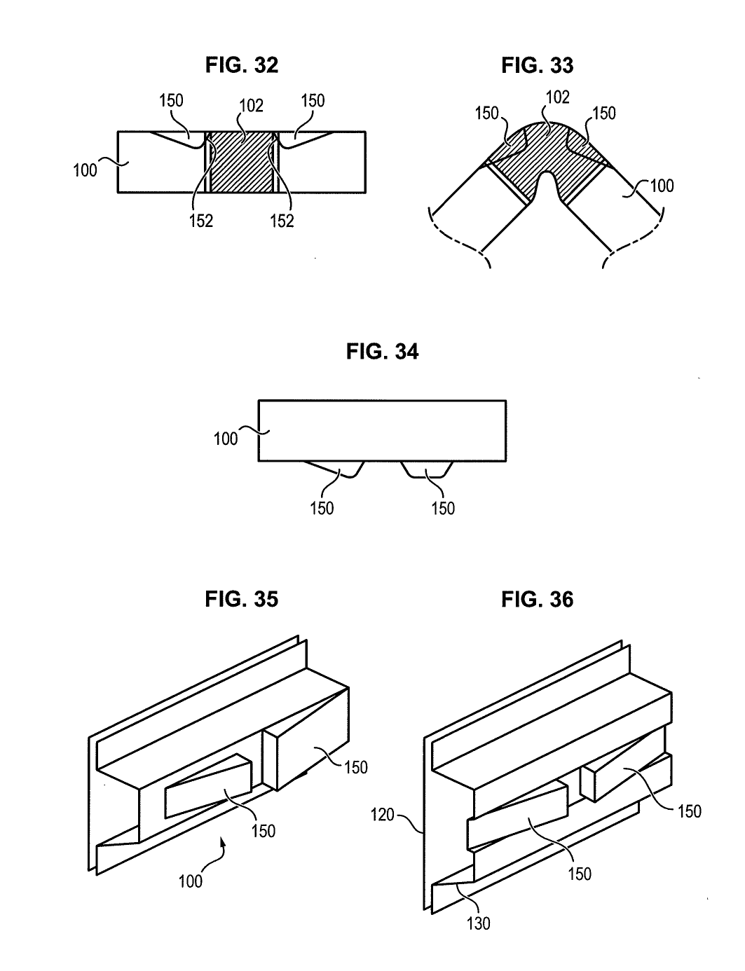

FIG. 32 shows a similar part to that of FIG. 30 having a controlled resistance area,

FIG. 33 shows the part in FIG. 32 after bending,

FIG. 34 shows an embodiment variant in which the bosses are dissymmetrical,

FIG. 35 shows a perspective view of the part in FIG. 34,

FIG. 36 shows an embodiment variant of FIG. 35 in which the bosses are formed in the bottom of longitudinal grooves formed on an exterior face of the part,

FIGS. 37, 38, 39, 40, 41 and 42 show cross-sectional views of parts according to various embodiment of the invention,

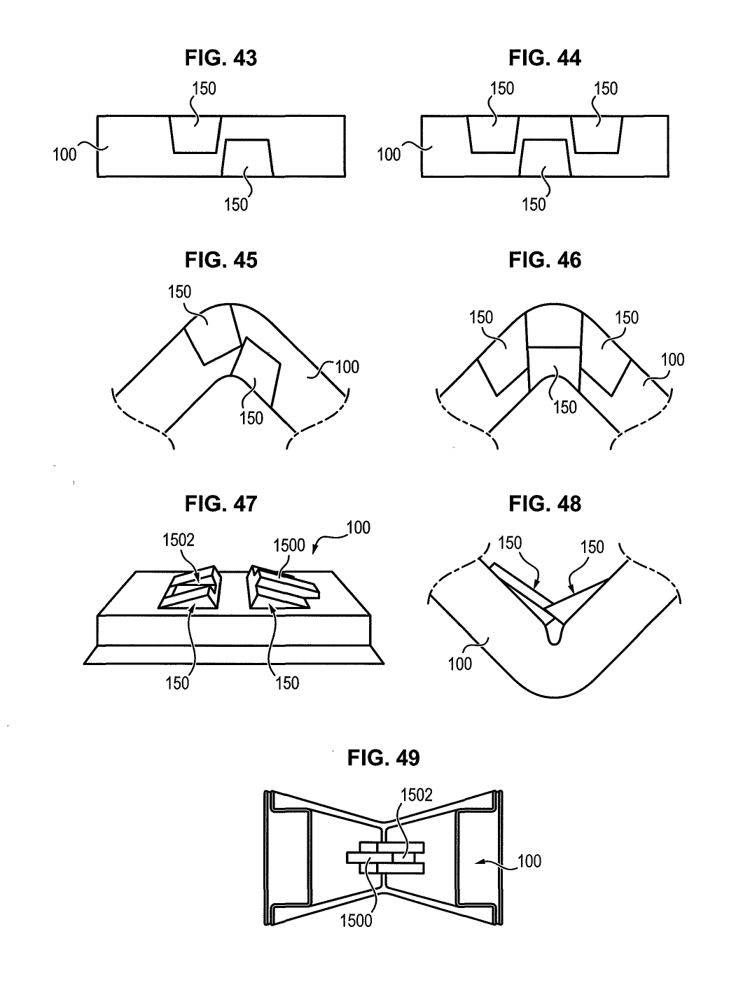

FIG. 43 shows a sectional view of a part, according to an implantation variant of the bosses, before bending,

FIG. 45 shows the part in FIG. 43 after bending,

FIG. 44 shows a variant of the embodiment of FIG. 43 before bending,

FIG. 46 shows the part in FIG. 44 after bending,

FIG. 47 shows a perspective view before bending of a part, according to an embodiment of the invention, adapted to ensure a blocking in 3 axes X, Y and Z, when the part bends,

FIG. 48 shows a top view of the part in FIG. 47 after bending,

FIG. 49 shows another perspective view of FIG. 48,

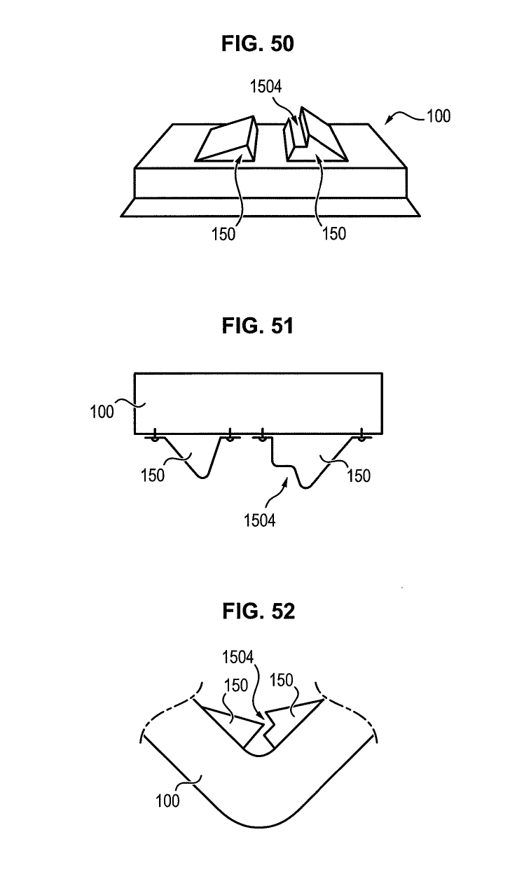

FIG. 50 shows a perspective view of another embodiment of the invention, before bending,

FIG. 51 shows a top view of the part in FIG. 50 before bending and

FIG. 52 shows a top view of the part in FIG. 51 after bending.

In the attached FIG. 3, an exemplary embodiment of a metal beam, according to the present invention, is shown.

The beam 100 illustrated in FIG. 3 is formed by a tube which comprises, on one of its inner faces 110, a series of pre-formed bosses 150 distributed along its length and defining gaps 159 therebetween.

It is understood on the comparative examination of FIGS. 3 and 4, that the bending angle of the structural part 100 about an axis transverse to its length is limited when the flanks 152, 154 of two adjacent bosses 150 come into contact as illustrated in FIG. 4.

Where appropriate, the above mentioned gaps 159 formed between two adjacent bosses 150 can be rectangular in section so that the bending is limited when two adjacent bosses 50 abut at their top level.

Preferably, however, as has been illustrated in the accompanying figures, according to the invention the bosses 150 define between them dihedron shaped gaps 159, of increasing section towards the top of the bosses, so that the bending is limited when two adjacent bosses 150 abut on substantially all of their opposing faces 152 and 154.

As shown schematically in FIG. 4 attached, preferably the bosses 150 are formed on an inner face of the beam 100, and not on an outer face thereof, so that the beam does not have external rough bits. This arrangement is applicable to all of the embodiment variants of the invention.

Preferably the bosses 150 are defined by generatrices all parallel to one another and parallel to an axis of curvature.

These generatrices defining the bosses are preferably orthogonal to the longitudinal axis or main axis of elongation of the part. Thus, the bosses 150 extend transversely to the longitudinal axis or main axis of elongation of the part.

In this case, the bosses 150 have constant sections along their entire width and the part bends around the aforementioned axis of curvature by deforming itself in an orthogonal plane to this axis.

However, if it is desired to impose a bending of the part in three dimensions, that is to say imposing a bending about an axis which is not orthogonal to a median plane of the part bent, there can be provided bosses 150 whose side walls are defined by generatrices parallel to one another so that the bosses have a variable section over their width.

According to the embodiments illustrated in FIGS. 3 to 5, all of the bosses have identical sections in the shape of an isosceles trapezoid (base 151 and top face 153 parallel to one another, and side walls 152, 154 of the same height, being two equal angles adjacent to the base 151). The base 151 is adjacent to the inner face of the part 100. The upper face 153 is parallel to the base 151. And the side walls 152 and 154 form the side of the trapezium. In this case, if the gaps 159 are also all identical, the invention leads to a constant radius of curvature.

However, as shown in FIG. 6, gaps 159 of variable cross-sections, and as shown in FIG. 7, bosses 150 of variable cross-sections may be provided to define a changing radius of curvature according to the considered length of the area of the part 100. In this case the bosses 150 may have an isosceles trapezium section but having different angles one to the other, or have a trapezium section, that is to say, that the two adjacent angles at the base 151 are not equal).

Obviously, the arrangements shown in FIGS. 6 and 7 can be combined, that is to say, that the combination of gaps 159 of variable cross-sections with the bosses 150 of variable cross-sections can be provided.

The bosses 150 may be integral on the part 100, for example, they may be formed by machining. They can be formed from a part added on the beam 100.

The bosses 150 can also be formed by stamping of the part 100, as shown in FIG. 9. Actually, in FIG. 9 two bosses 150 made by stamping and having the opposing faces 152, 154 adapted to come into contact as shown in FIG. 10 when bending of the part 100 reaches a threshold, can be seen.

According to a particular and non-limiting embodiment, according to the invention, the bosses 150 have a flat top face 153 and side walls 152, 154 inclined in relation to their base 151 at an angle α between 40° and 80°, preferably of approximately 60°.

In attached FIG. 8, an embodiment according to the present invention has been represented, whereby two bosses 150 are fixed at the level of the area of a part, in which it is particularly desirable to control the curvature, i.e. in this case limit the radius of curvature to prevent accidental breakage. The person skilled in the art, on considering FIG. 8, will understand that the present invention can thus be applied to a limited area of a part.

Moreover, it will be observed that according to the embodiment illustrated in FIG. 8, the two bosses 150 are based on a longitudinal rib 90 formed on the part 100. The term “longitudinal rib 90” means the rib 90 extends parallel to the longitudinal axis or axis of main elongation of the part 100. The rib 90 is formed, for example of two flanks 92, 94 connected to the body of the part 100 and a top 96 that connects the flanks 92, 94 to one another, and extends parallel to the median plane of the body of the part 100. The flanks 92, 94 are overall non-parallel to the body of the part 100. Preferably, they form between them a concave dihedron towards the body of the part 100, for example in being inclined between them at an angle between 45° and 90°, typically of approximately 80°.

The person skilled in the art will understand that the presence of such a longitudinal rib 90 allows stiffening the part with respect to a bending load around an axis perpendicular to its longitudinal axis or axis of main elongation.

The presence of such a longitudinal rib 90 is applicable to all the embodiments of the present invention, over the entire length of the part 100 or only a portion of that length. The rigidity associated with the rib 90 can easily be adapted for controlling the rigidity, for example the thickness and the height of the flanks 92, 94.

The bosses 150, for example, can be made in the form of stamped steel parts and attached, for example by soldering them on the part 100.

In FIGS. 12, 13 and 14, three embodiments, according to the present invention, are shown, whereby the two bosses 150 are formed by means 160, in this case a plate 162 for example of metal, adapted to be deformed when bending and thus forming at least two bosses 150 capable of coming into contact if the bending angle exceeds a threshold.

According to the embodiment shown in FIG. 12, the plate 162, which is fixed on the beam 100 at its ends 163, 164 respectively at both sides of the bending area 102, has a rib 165 in its center, for example in the shape of an outwardly convex dihedron. During a marked bending, the legs of the rib 165 connecting the rib 165 to the two end sections of the plate 162 abut and limit the bending.

According to the embodiment shown in FIG. 13, the plate 162 fixed on the beam 100 at its ends 163, 164 respectively of both sides of the bending area 102 is initially flat, but has two elements 166, 167 that initiate folding parallel to one another, and are arranged, respectively, on both sides of the bending area. During a marked bending, the part 162 deforms generating a bulge between the two elements 166, 167 initiating the folding so that the sides of the cited bulge, which connect said bulge to two sections of the end of the plate 162, abut and limit bending.

According to the embodiment shown in FIG. 14, the plate 162, which is initially flat, is fixed on the beam 100 at its ends 163, 164 respectively at both sides of the bending area 102 and at its center 168 at the level of the bending area. Upon marked bending, as illustrated in FIG. 14, the part 162 deforms generating two bulges 170, 172 respectively between the central fixing means 168 and the two side fixing means 163, 164, so that the tops of the bulges 170, 172 abut and limit bending.

FIG. 15, which shows a top view of a part according to FIG. 14 before bending, particularly illustrates the welding points 163, 164, 1630 of the plate 162 on the beam.

FIG. 16, which shows a top view of a part according to an embodiment variant of FIG. 15, shows the same points of welding and shows folding initiating elements formed as ribs 165a and 165b made between the central fixing means 1630 and the side fixing means 163 and 164. The ribs 165a and 165b can be rectilinear and parallel to the desired bending axis.

FIG. 17, which shows a top view of a part according to FIG. 15 or 16 after bending, shows the cooperation defined between the tops of the bosses for limiting the bending.

FIG. 18, which shows a top view of a part according to FIG. 12 or 13 after bending, shows the cooperation defined between the legs of the bulges for limiting the bending.

FIG. 19, which shows a top view of a part according to FIG. 15, in particular shows an area 102 having controlled mechanical properties, before bending. Said area 102 will be described in more detail below.

FIG. 20 shows a top view of the part in FIG. 19 after bending, and illustrates the impact of the area 102 enabling the bending.

FIG. 21 shows a top view of a part according to FIG. 5 before bending, and illustrates the possibility of fixing through welding a preformed part having bosses on a beam.

FIG. 22 shows the part in FIG. 21 after bending,

FIGS. 23, 24 and 25 show cross-sectional views of parts according to the invention, and illustrate the possibility of arranging the means of bending limitation on an inner face of the part. According to FIG. 23, the bending limitation means are formed by a plate 162 similar to FIG. 16 with two initiating elements 165a and 165b. According to FIG. 24, the bending limitation means are similar to those of FIGS. 8 and 21. FIG. 25 particularly illustrates the possibility of combining the bending limitation means with an area 102 with controlled mechanical properties.

FIGS. 28 and 29, which show respectively a part before and after bending, particularly illustrate the possibility of combining an area 102 with controlled mechanical resistance at the level of the areas intended to operate the bending, with the bending limitation means illustrated in FIGS. 26 and 27.

Similarly, FIGS. 32 and 33, which show respectively a part before and after bending, particularly illustrate the possibility of combining an area 102 with controlled mechanical resistance at the level of the areas intended to operate the bending, with the bending limitation means illustrated in FIGS. 30 and 31.

FIG. 34 shows a part of an embodiment variant according to which the bosses are asymmetrical, one of the bosses having a generally triangular right hand section, while the adjacent boss has a generally rectangular section.

FIG. 35 shows a perspective view of the part in FIG. 34, and thus illustrates the bosses formed by stamping on the bottom of the part of a beam as illustrated in FIG. 39.

FIG. 36 shows an embodiment variant of FIG. 35, in which the bosses are formed in the bottom of longitudinal grooves formed on an outer face of the part bottom, of the part illustrated in FIG. 39.

Obviously, the means 160 may the object of other embodiments, adapted to be deformed during bending and thereby forming at least two bosses capable of coming into contact if the bending angle exceeds a threshold.

According to another advantageous feature, the elongated metal part, according to the present invention, comprises at least one area having controlled properties of lower mechanical resistance than the main body of said metal part at the level of area 102 intended to be bent. The presence of an area 102 having controlled lower mechanical resistance properties than the main body of the part can be applied to all embodiments of the invention.

Preferably, this area 102 of low mechanical resistance is made according to a method comprising heating a metal flan to a temperature above the austenite transition temperature, and then shaping the thus heated flan in a stamping tool having a controlled cooling circuit and locally a heating system, thus allowing, through differential quenching, to obtain varied mechanical properties.

In FIGS. 11, 19, 20, 25, 28, 29, 32 and 33 the low mechanical resistance area 102 is shown with hatched lines.

The presence of the area 102 with predefined low resistance allows controlling the bending site and ensuring the effectiveness of the limitation means based on bosses.

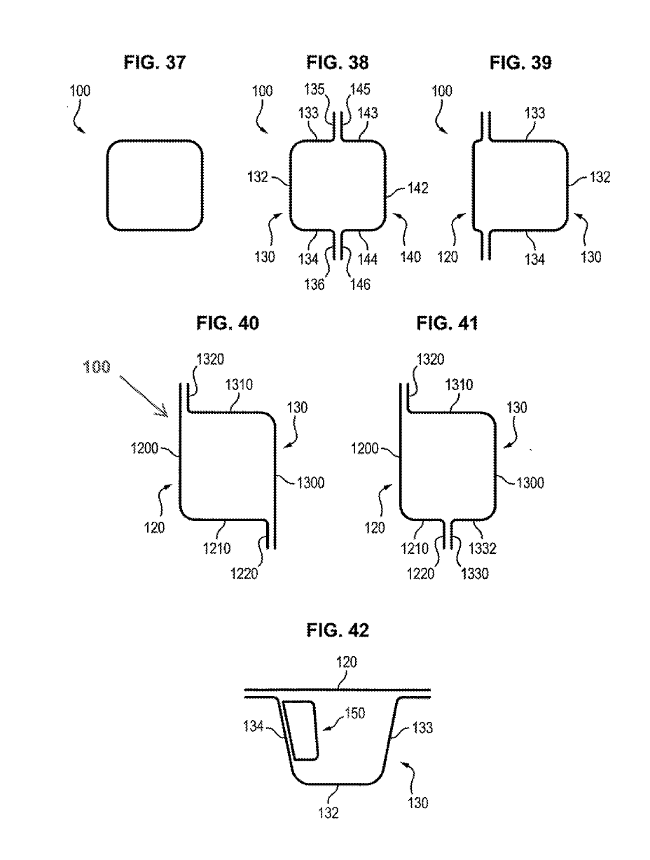

As mentioned previously, the beam 100 may be an integral one-piece tube of any polygonal or curved section, for example but not limited to a square section tube as shown in FIG. 37, or a tube formed by the assembly of several parts as shown in FIGS. 38 to 41.

In FIG. 38, the beam 100 is formed by assembling two symmetrical parts 130, 140, mounted head to tail, each formed by a part bottom 132, 142 framed by two transverse walls 133, 134 and 143, 144, forming a U with the part bottom 132 and 142, said walls being extended, at their free ends opposite to the part bottom 132, 142, by two flanges 135, 136 and 145, 146 outwardly directed and generally parallel to the part bottom 132, 142. The two parts 130 and 140 are fixed, for example by welding, by their flanges 135, 136 and 145, 146 respectively contiguous.

In FIG. 39, the beam 100 is formed by assembling two parts 130, 120. The part 130 has a part bottom 132 framed by two transverse walls 133, 134 forming a U with the part bottom 132, said walls 133, 134 being extended at their free ends opposite the part bottom 132 by two flanges 135, 136 outwardly directed and generally parallel to the part bottom 132. The part 120 forms a generally flat cover, but may include a rib in its central part, covering the part 130 and contiguous to the flanges 135, 136. The two parts 120 and 130 are fixed, for example by welding, at the flanges 135, 136.

In FIG. 40, the beam 100 is formed by assembling two parts 120, 130 generally symmetrical with each one having two orthogonal principal partitions 1200 and 1210, 1300 and 1310 between them, one of which is extended by an orthogonal fin 1220, 1320. The fins 1220 and 1320 being contiguous to the partitions 1300 and 1200, the said partitions 1200 and 1210, 1300 and 1310 together define a square section central well.

FIG. 41 shows an embodiment of FIG. 40 according to which the two parts 120, 130 are not symmetrical so that one of the partitions 1300 has a fin 1330 connected by a recess 1332 so that the fin 1330 contiguous to the fin 1220 is located at half the width of the square section central well.

FIG. 42 illustrates the possibility of arranging the bosses on a wall 133 or 134 of a part, for example as shown in FIG. 39.

Obviously, the present invention is not limited to the embodiments described above, but extends to all variants within its scope.

FIG. 43 shows a sectional view of a part, according to an implantation variant of the bosses, before bending. In this case there are provided two bosses substantially opposite of each other and while also offset from each other so that one of the respective side walls can come into contact upon bending, respectively, on the opposite inner faces of the beam.

FIG. 45 shows the part in FIG. 43 after bending, and illustrates the cooperation between the bosses so defined.

FIG. 44 shows an embodiment variant of FIG. 43, before bending, wherein there are two bosses on an inner face of a beam and a third boss on an opposite inner face of the beam, opposite the gap defined between the two first mentioned bosses.

FIG. 46 shows the part in FIG. 44 after bending,

FIG. 47 shows a perspective view before bending of a part, according to an embodiment of the invention, adapted to ensure a blocking in 3 axes X, Y and Z, once the bending has occurred. In this case, there are provided two bosses 150 adapted to abut and engage in bending of the beam about an axis X, the two bosses having form-fitting structures capable of fitting into each other upon bending along the X axis to prevent any movement along the respectively orthogonal axes Y and Z. The above form-fitting structures may have, for example, a rib 1500 directed transversely to the axis X on one of the bosses and a complementary groove 1502 on the opposite boss. Obviously, many configurations of form-fitting structures can be considered.

FIG. 48 shows a top view of the part in FIG. 47 after bending.

FIG. 49 shows another perspective view of FIG. 48, after bending.

FIGS. 50 and 51 show perspective views of another embodiment of the invention, before bending, wherein one of the bosses 150 has in its top a concave recess 1504 adapted to receive the complementary convex top of the boss adjacent, upon bending, as illustrated in FIG. 52.

1. A metal rail of a motor vehicle underbody, comprising,
a structure of the rail, the structure selected from the group including a one-piece tube of a polygonal or curved cross-section, or a tube formed by assembling several parts and comprising, at least on one face of the structure, elements adapted to form, upon bending of the structure, at least two adjacent bosses that are brought into contact by the bending so that the bending of the structure is limited when at least portions of opposing faces of the at least two adjacent bosses abut.

2. The rail according to claim 1, wherein the at least two adjacent bosses comprises, at least on one face of the structure, at least two preformed bosses defining gaps of a cross-section between the bosses, and wherein a cross-section of the structure is such that the bending of the rail is limited by at least portions of opposite faces of two of the at least two adjacent bosses abutting.

3. The rail according to claim 1, wherein the at least two adjacent bosses comprises, at least on one face of the structure, a series of bosses, distributed over a length of the structure and defining gaps of a cross-section of the structure between the bosses, and the cross-section is such that the bending of the rail is limited when at least portions of opposite faces of two adjacent bosses abut.

4. The rail according to claim 1, wherein the at last two adjacent bosses define gaps between the bosses, and a cross-section of the gaps increases towards a top of the bosses.

5. (canceled)

6. (canceled)

7. The rail according to claim 1, wherein the at least two adjacent bosses have variable cross-sections along a length of the rail.

8. (canceled)

9. The rail according to claim 1, wherein the at least two adjacent bosses have cross-sections of trapezoidal shape.

10. The rail according to claim 1, wherein the at least two adjacent bosses have a flat top face and flanks inclined in relation to a base at an angle α between 40° and 80°.

11. The rail according to claim 1, wherein the at least two adjacent bosses are formed by stamping.

12. The rail according to claim 1, further comprising elements adapted to be deformed upon bending of the structure, whereupon bending the elements form the at least two adjacent bosses capable of coming into contact with each other if a bending angle exceeds a threshold bending angle.

13. The rail according to claim 12, wherein the elements comprise a plate adapted to be deformed upon the bending of the structure and forming the at least two adjacent bosses capable of coming into contact with each other if the bending angle exceeds the threshold bending angle.

14. The rail according to claim 13, wherein ends of the plate is are fixed on the rail respectively on either side of a bending area and the plate includes an outwardly convex rib in its centre, whose legs abut upon bending.

15. The rail according to claim 13, wherein ends of the plate are fixed on the rail at its ends respectively on either side of a bending area, the plate being initially flat but having two folding initiating elements respectively on either side of the bending area, so that the part deforms generating a bulge between the two folding initiating elements and the sides of the bulge connecting the bulge to the two end sections of the plate abut upon bending.

16. The rail according to claim 13, wherein a flat plate having ends and a center is fixed on the rail at its ends respectively on either side of a bending area and at its center at the level of the bending area, so that the part deforms generating two bulges respectively between the central fixing means and the two side fixing means and the tops of the bulges abut upon bending.

17. The rail according to claim 1, wherein the at least two adjacent bosses are formed on an inner face of the rail.

18. The rail according to claim 17, wherein the at least two adjacent bosses are provided on two opposing inner faces of the rail.

19. The rail according to claim 1, wherein the at least two adjacent bosses are integrally formed with the rail.

20. The rail according to claim 1, wherein the at least two adjacent bosses are formed by a part added to the rail.

21. (canceled)

22. (canceled)

23. The rail according to claim 1, wherein one of the at least two adjacent bosses has in a top thereof a structure adapted to receive a complementary top of an adjacent boss, upon bending.

24. The rail according to claim 1, wherein the rail comprises at least one bending area of lower mechanical resistance than a main body of the rail.

25. The rail according to claim 1, wherein the rail is made from a square tube.
